(19) United States
(12) Patent Application Publication
(10) Pub. No.: US 2025/0321050 A1
(43) Pub. Date: Oct. 16, 2025

(54) PROCESS AND APPARATUS FOR THE PRODUCTION OF AMMONIA SYNTHESIS GAS

(71) Applicant: L'Air Liquide, Societe Anonyme pour l'Etude et l’Exploitation des Procedes Georges Claude, Paris (FR)

(72) Inventors: Antoine HERNANDEZ, Paris (FR); Naila BALI, Paris (FR)

(21) Appl. No.: 19/174,152

(22) Filed: Apr. 9, 2025

(30) Foreign Application Priority Data
Apr. 11, 2024 (FR) FRFR2403780

(51) Int. Cl. F25J 3/02

(52) U.S. Cl. CPC F25J 3/0223; F25J 3/0233; F25J 3/0252; F25J 3/0261; F25J 3/0276; F25J 3/0285; F25J 2205/30; F25J 2210/18

(57) ABSTRACT

In a process for the production of an ammonia synthesis gas, a gas mixture containing hydrogen, argon, carbon monoxide, carbon dioxide and methane originates from a reformer in combination with a combustion unit, the mixture being treated to remove the carbon dioxide which it contains before being cooled and separated in a cryogenic separation unit in a thermally insulated chamber, the mixture being separated to provide a liquid which is vaporized and sent as fuel to the combustion unit having been purified of carbon monoxide and/or methane.

### CROSS REFERENCE TO RELATED APPLICATIONS

This application claims the benefit of priority under 35 U.S.C. § 119 (a) and (b) to French patent application No. FR2403780, filed Apr. 11, 2024, which is herein incorporated by reference in its entirety.

### FIELD OF THE INVENTION

The present invention relates to a process and apparatus for the production of an ammonia synthesis gas. It uses a process for the purification of hydrogen by washing with nitrogen with recovery of methane.

### BACKGROUND OF THE INVENTION

Units for the synthesis of ammonia are fed with a stoichiometric H₂/N₂ mixture.

Some compounds, such as argon, methane, oxygen, CO, CO₂ or others, are regarded as inert compounds or as poisons of catalysts for the synthesis of ammonia.

It is thus necessary to purify the hydrogen which can be produced by a steam reforming reactor, by an autothermal reactor or by a coal gasification reactor, to name only the commonest.

One of the processes for the purification of this hydrogen operates cryogenically and is known under the name of liquid nitrogen wash, where the impure hydrogen is treated counter-current-wise in a column where it is sent to the bottom while the column is fed at the top with a stream of liquid nitrogen.

The impure hydrogen produced by a steam reforming or coal gasification reactor is treated in a first step in a unit for the removal of acid gases of CO₂ or H₂S type in order to be sent to an adsorption purification unit in order to remove the components, which can solidify in the cold box.

On leaving this adsorption, the impure hydrogen is treated in a cold box. This hydrogen is cooled down to a temperature in the vicinity of −182° C./−190° C. in order to feed the bottom of a washing column where liquid nitrogen is injected at the top, it being possible for this liquid nitrogen to be produced by an air separation unit in gaseous form and liquefied in the main exchanger. The liquid from the bottom of the washing column containing the impurities CO, Ar and CH₄ is vaporized in the main exchanger before being used, for example as fuel.

In the case where the content of CH₄ in the impure hydrogen is of the order of several molar %, it is known from WO 2012/097497 to separate the liquid phase created before entering the nitrogen washing column and to thus produce a fluid richer in CH₄.

A pure H₂+N₂ mixture for the synthesis of NH₃ is thus produced at the top of the washing column. A fluid rich in CH₄ can be recycled upstream or feed a unit for the production of H₂, and also a “waste” fluid, used as fuel, containing a mixture of CO and of Ar with residual contents of CH₄, H₂ and N₂.

The waste fluid is used as fuel and for example is incinerated in a combustion unit, for example a combustion unit where the combustion takes place in a closed chamber, the combustion heat being transferred to the air by indirect heat transfer (indirect fired heater). Heat can also be transferred by direct heat exchange. This combustion unit can generate heat for a reformer producing a mixture of carbon monoxide and of hydrogen, for example an autothermal reformer. In point of fact, it generates flue gases containing CO₂ which are emitted in particular by the combustion of the CO contained in the waste fluid.

### SUMMARY OF THE INVENTION

One aim of certain embodiments of the invention is to reduce the production of CO₂ coming from this combustion unit by modifying the composition of the waste fluid used as fuel in order to reduce its content of carbon monoxide and/or methane.

According to certain embodiments of the invention, a process for the production of an ammonia synthesis gas is provided in which a gas mixture containing hydrogen, argon, carbon monoxide, carbon dioxide and methane originates from a reformer, the mixture being treated to remove the carbon dioxide which it contains before being cooled and separated in a cryogenic separation unit in a thermally insulated chamber, the mixture being separated in a first column for washing with liquid nitrogen to produce, at the column top, a first gas which is the ammonia synthesis gas and, at the bottom, a first liquid containing nitrogen, hydrogen, argon, carbon monoxide and methane, the liquid is separated in a second separation column to produce a second column top gas enriched in hydrogen and a second liquid depleted in hydrogen and enriched in methane and in argon, the second liquid depleted in hydrogen is sent to a third separation column which produces, at the bottom, a third liquid enriched in methane and a third top gas which is sent to a fourth separation column which produces, at the bottom, a fourth liquid enriched in argon and a fourth top gas, the fourth gas being sent to a fifth column which produces a fifth liquid rich in carbon monoxide and a fifth gas rich in nitrogen, the fourth liquid being vaporized and sent as fuel to a combustion unit which produces flue gases containing CO₂ and heat which is used in the process for the production of the gas mixture.

According to other optional characteristics:
the third and/or the fifth liquid is vaporized and sent upstream of the reformer,
a fuel, for example natural gas, is optionally treated in a desulfurization unit, subsequently sent to a pre-reformer and the reformer producing a gas which is treated by at least one shift operation producing the mixture containing hydrogen, argon, carbon monoxide, carbon dioxide and methane,
the third and/or the fifth liquid is sent upstream of the pre-reformer or upstream of the desulfurization unit,
no part of the fourth liquid is sent upstream of the reformer,
at least 50%, indeed even at least 70%, of the carbon monoxide present in the gas mixture at the inlet of the thermally insulated chamber is recycled upstream of the reformer,
at least 50%, indeed even at least 70%, of the methane present in the gas mixture at the inlet of the thermally insulated chamber is recycled upstream of the reformer,
less than 50%, indeed even less than 30%, of the carbon monoxide present in the gas mixture at the inlet of the thermally insulated chamber is sent to the combustion unit,
less than 50%, indeed even less than 30%, of the methane present in the gas mixture at the inlet of the thermally insulated chamber is sent to the combustion unit,
the first, second, third, fourth and fifth columns are found inside a single thermally insulated chamber.

According to another subject-matter of the invention, an apparatus for the production of ammonia synthesis gas is provided which comprises a cryogenic separation unit comprising a first column for washing with liquid nitrogen, a second separation column, a third separation column, a fourth separation column and a fifth column, a thermally insulated chamber, means for treating a gas mixture containing hydrogen, argon, carbon monoxide, carbon dioxide and methane originating from a reformer, to remove the carbon dioxide which it contains, means for cooling the mixture purified of carbon dioxide, means for sending the cooled and purified mixture to be separated into the cryogenic separation unit in the thermally insulated chamber, in the first column for washing with liquid nitrogen to produce, at the column top, a first gas which is the ammonia synthesis gas and, at the bottom, a first liquid containing nitrogen, hydrogen, argon, carbon monoxide and methane, means for sending the first liquid to be separated into the second separation column to produce a second column top gas enriched in hydrogen and a second liquid depleted in hydrogen and enriched in methane and in argon, means for sending the second liquid depleted in hydrogen to the third separation column which produces, at the bottom, a third liquid enriched in methane and a third top gas, means for sending the third top gas to the fourth separation column which produces, at the bottom, a fourth liquid enriched in argon and a fourth top gas, means for sending the fourth gas to a fifth column which produces a fifth liquid rich in carbon monoxide and a fifth gas rich in nitrogen, means for vaporizing the fourth liquid and means for sending the vaporized fourth liquid as fuel to a combustion unit which produces flue gases containing CO₂ and heat which is used to produce the gas mixture.

According to other aspects of the invention, the apparatus comprises:
vaporization means, means for sending the third and/or the fifth liquid to vaporize in the vaporization means and means for sending the vaporized liquid upstream of the reformer,
a desulfurization unit and a pre-reformer upstream of the reformer, a shift unit downstream of the reformer, means for sending a fuel to be treated in the desulfurization unit, means for sending the treated fuel to the pre-reformer and the reformer, means for sending a gas produced by the reformer to the shift unit in order to produce the mixture containing hydrogen, argon, carbon monoxide, carbon dioxide and methane.

### BRIEF DESCRIPTION OF THE DRAWINGS

The invention will be understood better from reading the following description and from studying the accompanying figures. These figures are given only by way of illustration and do not in any way limit the invention.

FIG. 1 diagrammatically represents a process for the production of ammonia synthesis gas.

FIG. 2 represents the cryogenic separation of the gas mixture used to produce the ammonia synthesis gas.

### DETAILED DESCRIPTION OF THE INVENTION

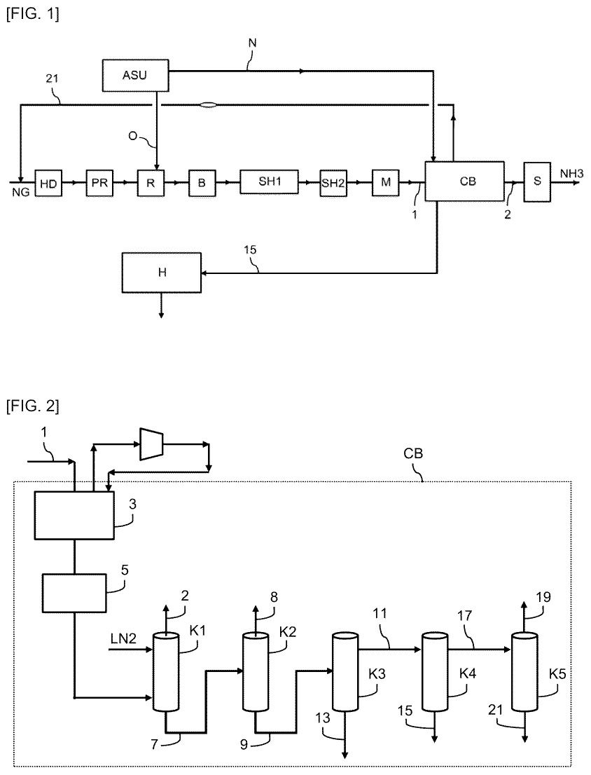

FIG. 1 represents a process for the production of ammonia synthesis gas NH₃ in which a flow of hydrocarbons NG, for example natural gas, is sent to an optional desulfurization unit HD. The gas is subsequently sent to a pre-reformer PR and to a reformer R, for example of autothermal type, heated by the heat of a combustion unit H fed with hydrocarbons NG, for example natural gas. The reformer produces a gas which comprises predominantly hydrogen, carbon monoxide, carbon dioxide, methane and argon. This gas is heated in a unit B and subsequently a part of the carbon monoxide which it contains is converted to carbon dioxide in two shift units SH1, SH2. The acid gases, such as carbon dioxide, are partially removed in a washing unit M, for example by a process of Rectisol® type using washing with methanol. The gas, purified of acid gas, is subsequently sent to a unit for purification by adsorption (not illustrated) in order to remove the components which may solidify during the cryogenic separation.

The mixture 1 entering the cryogenic chamber CB still contains hydrogen, carbon monoxide, carbon dioxide, methane and argon. The mixture is separated by cryogenic separation comprising washing with liquid nitrogen in a separation unit CB which produces the ammonia synthesis gas 2 containing nitrogen and hydrogen. The gas 2 is sent to an ammonia production unit S.

An air separation unit ASU produces nitrogen N for the washing with nitrogen in the unit CB and oxygen O for the reformer.

A gas 15 containing argon is sent to a combustion unit H and a gas 21 containing carbon monoxide and/or methane is sent upstream of the reformer R (or upstream of the pre-reformer PR or upstream of the desulfurization unit HD). The combustion unit H produces heat for the reformer R and comprises burners.

FIG. 2 represents a thermally insulated chamber CB containing two heat exchangers 3, 5, a first separation column K1 which is a column for washing with liquid nitrogen, a second separation column K2, a third separation column K3, a fourth separation column K4 and a fifth separation column K5.

The mixture 1, at the outlet of the adsorption, containing hydrogen, carbon monoxide, carbon dioxide, methane and argon, is cooled in the heat exchangers 3, 5 down to a temperature in the vicinity of −182° C./−190° C. Nitrogen N originating from the air separation also liquefies in these exchangers. The cooled mixture 1 is sent to the bottom of the washing column K1 and the liquefied nitrogen is sent to the top, so that an ammonia synthesis gas 2 is produced at the top of the column K1. The bottom liquid, containing nitrogen, hydrogen, carbon monoxide, methane and argon, is sent to the second column K2 in order to reduce its hydrogen content, a flow 8 enriched in hydrogen exiting from the top of the column K2 and a liquid 9 containing proportionally less hydrogen than the liquid 7 exiting from the bottom of the column K2. The liquid 9 is sent to a third column which produces, at the bottom, a liquid enriched in methane 13 with respect to the liquid 7 and a top gas 11 depleted in methane with respect to the liquid 7. The gas 11 is sent to a fourth column which produces, at the bottom, a liquid enriched in argon 15 with respect to the gas 11 and a top gas 17 depleted in argon and methane with respect to the gas 11.

The gas 17 is separated in a fifth column K5 in order to produce, at the top, a flow 19 enriched in nitrogen and depleted in carbon monoxide with respect to the gas 17 and, at the bottom, a liquid 21 enriched in carbon monoxide and depleted in nitrogen with respect to the fluid 17.

The liquid 15 enriched in argon is sent as fuel to the combustion unit H. As a part of the methane has already been removed in the column K3, the liquid 15 contains less methane than it would contain if the column K3 were not present.

The liquid 13 enriched in methane and/or the liquid 21 enriched in carbon monoxide are vaporized and sent either just upstream of the reformer R between the reformer R and the pre-reformer PR, or just before the pre-reformer PR, or just before the desulfurization unit HD.

Thus, by successive separation by columns K1 to K5 containing internals making possible mass transfer between the liquid and gas phases, the thermally insulated chamber CB containing the column for washing with nitrogen K1 is capable of producing a H₂+N₂ mixture for the synthesis of NH₃, a CO-rich gas, CH₄ containing H₂ and N₂ which can be recycled upstream of the unit R which generates the H₂-rich fluid which is treated in the insulated chamber CB, and also a waste gas (produced by vaporizing the liquid 15) which contains the majority of the argon which cannot be recycled.

The majority of the CO and/or CH₄ is then separated and recycled upstream, which reduces their amount in the argon-rich fluid and thus considerably reduces the amount of CO₂ emitted by combustion of the argon-rich fluid.

At least 50%, indeed even at least 70%, of the carbon monoxide present in the gas mixture 1 at the inlet of the thermally insulated chamber is recycled upstream of the reformer R.

At least 50%, indeed even at least 70%, of the methane present in the gas mixture 1 at the inlet of the thermally insulated chamber CB is recycled upstream of the reformer R.

Less than 50%, indeed even less than 30%, of the carbon monoxide present in the gas mixture at the inlet of the thermally insulated chamber CB is sent to the combustion unit H in combination with the reformer R.

Less than 50%, indeed even less than 30%, of the methane present in the gas mixture at the inlet of the thermally insulated chamber CB is sent to the combustion unit H in combination with the reformer R.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A process for the production of an ammonia synthesis gas from a gas mixture comprising hydrogen, argon, carbon monoxide, carbon dioxide, and methane, the process comprising the steps of:
providing the gas mixture, wherein the gas mixture originates from a reformer, the gas mixture;
treating the gas mixture to remove the carbon dioxide before cooling the gas mixture;
introducing the gas mixture after cooling into a cryogenic separation unit disposed within a thermally insulated chamber, wherein the cryogenic separation unit comprises a first column, a second column, a third column, a fourth column, and a fifth column;
introducing the gas mixture to the first column that is configured to wash the gas mixture with liquid nitrogen, thereby producing a first gas at a top portion of the first column and a first liquid at a bottom portion of the first column, wherein the first gas comprises the ammonia synthesis gas, wherein the first liquid comprises nitrogen, hydrogen, argon, carbon monoxide and methane;
introducing the first liquid to the second column, which is configured to separate the first liquid into a second top gas enriched in hydrogen and a second liquid depleted in hydrogen and enriched in methane and in argon;
introducing the second liquid to the third column, which is configured to produce a third liquid at a bottom portion of the third column and a third top gas at a top portion of the third column, wherein the third liquid is enriched in methane;
introducing the third top gas to the fourth column that is configured to produce a fourth liquid at a bottom portion of the fourth column and a fourth top gas at a top portion of the fourth column, wherein the fourth liquid is enriched in argon;
introducing the fourth top gas to the fifth column that is configured to produce a fifth liquid rich in carbon monoxide and a fifth gas rich in nitrogen; and
vaporizing the fourth liquid enriched in argon and sending the vaporized fourth liquid to a combustion unit, wherein the combustion unit produces heat and a flue gas comprising carbon dioxide,
wherein heat from the combustion unit is used in the reformer.

2. The process according to claim 1, wherein the third and/or the fifth liquid is vaporized and sent upstream of the reformer.

3. The process according to claim 1, wherein natural gas is optionally treated in a desulfurization unit, subsequently sent to a pre-reformer and the reformer producing a gas which is treated by at least one shift operation, thereby producing the gas mixture containing hydrogen, argon, carbon monoxide, carbon dioxide and methane.

4. The process according to claim 2, wherein the third and/or the fifth liquid is sent upstream of the pre-reformer or upstream of the desulfurization unit.

5. The process according to claim 1, wherein no part of the fourth liquid is sent upstream of the reformer.

6. The process according to claim 1, wherein at least 50% of the carbon monoxide present in the gas mixture at an inlet of the thermally insulated chamber is recycled upstream of the reformer.

7. The process according to claim 1, wherein at least 50% of the methane present in the gas mixture at an inlet of the thermally insulated chamber is recycled upstream of the reformer.

8. The process according to claim 1, wherein less than 50% of the carbon monoxide present in the gas mixture at an inlet of the thermally insulated chamber is sent to the combustion unit.

9. The process according to claim 1, wherein less than 50% of the methane present in the gas mixture at an inlet of the thermally insulated chamber is sent to the combustion unit.

10. An apparatus for the production of ammonia synthesis gas comprising:
a thermally insulated chamber,
a cryogenic separation unit disposed within the thermally insulated chamber, wherein the cryogenic separation unit comprises:
a first column configured to wash a gas mixture with liquid nitrogen to produce a first gas at a top portion of the first column and a first liquid at a bottom portion of the first column, wherein the first gas comprises the ammonia synthesis gas, wherein the first liquid comprises nitrogen, hydrogen, argon, carbon monoxide and methane;
a second separation column configured to separate the first liquid into a second top gas enriched in hydrogen and a second liquid depleted in hydrogen and enriched in methane and in argon;
a third separation column configured to produce a third liquid at a bottom portion of the third column and a third top gas at a top portion of the third column, wherein the third liquid is enriched in methane;
a fourth separation column configured to produce a fourth liquid at a bottom portion of the fourth column and a fourth top gas at a top portion of the fourth column, wherein the fourth liquid is enriched in argon; and
a fifth column configured to produce a fifth liquid rich in carbon monoxide and a fifth gas rich in nitrogen,
means for treating a gas mixture containing hydrogen, argon, carbon monoxide, carbon dioxide and methane originating from a reformer, to remove the carbon dioxide,
means for cooling the gas mixture purified of carbon dioxide,
means for sending the cooled and purified gas mixture to be separated into the cryogenic separation unit in the thermally insulated chamber,
means for vaporizing the fourth liquid; and
a combustion unit configured to receive the vaporized fourth liquid as fuel and produce heat and flue gases containing carbon dioxide, wherein the heat is used by the reformer to produce the gas mixture.

11. The apparatus according to claim 10, further comprising: vaporization means, means for sending the third liquid and/or the fifth liquid to vaporize in the vaporization means and means for sending the vaporized liquid upstream of the reformer.

12. The apparatus according to claim 10, further comprising a desulfurization unit and a pre-reformer upstream of the reformer, a shift unit downstream of the reformer, means for sending a fuel to be treated in the desulfurization unit, means for sending the treated fuel to the pre-reformer and the reformer, means for sending a gas produced by the reformer to the shift unit in order to produce the mixture containing hydrogen, argon, carbon monoxide, carbon dioxide and methane.
